(19) United States
(12) Patent Application Publication
(10) Pub. No.: US 2003/0200331 A1
(43) Pub. Date: Oct. 23, 2003

(54) Mechanism for communicating with multiple HTTP servers through a HTTP proxy server from HTML/XSL based web pages

(75) Inventors: Rakesh Mahajan, Laguna Hills, CA (US); Gopal Narayan, Lake Forest, CA (US); Shripathi Kamath, Mission Viejo, CA (US)

Correspondence Address: Lorraine Barrett, Suite E, 15520 Rockfield Blvd., Irvine, CA, 92618, US

(73) Assignee: NETAPHOR SOFTWARE, INC.

(21) Appl. No.: 10/393,120

(22) Filed: Mar. 20, 2003

Related U.S. Application Data
(60) Provisional application No. 60/368,311, filed on Mar. 28, 2002.

(51) Int. Cl. G06F 15/173; G06F 15/16

(52) U.S. Cl. 709/238; 709/236; 709/230

(57) ABSTRACT

A method for communicating with multiple HTTP servers through a HTTP proxy server from HTML/XSL web pages is disclosed. The method includes a mechanism allowing client web browsers to encode information within a URI that specifies the proxy server and actual server. This allows the client web browser to transmit a request without a proxy header. The server will recognize and handle proxying if it is necessary.

### CROSS-REFERENCE TO RELATED APPLICATIONS

This application claims priority from U.S. Provisional Application Serial No. 60/368,311, filed Mar. 28, 2002, by Mahajan et al, entitled “Mechanism for Communicating with Multiple HTTP Servers Through a AHTTP Proxy Server from HTML/XSL Based Web Pages”.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISK APPENDIX

Not applicable.

### BACKGROUND OF THE INVENTION

i) Field of the Invention

The present invention relates to mechanisms for communicating with multiple HTTP servers through a HTTP proxy server from HTML/XSL based web pages.

ii) Description of Prior Art

Web pages can communicate with remote servers via a proxy server after the browser is configured to direct all HTTP requests to go through the configured proxy server.

This forces other web pages to use the same proxy server because they share the browsers configuration settings. This proxy configuration method does not allow web pages to dynamically modify the address of the server used as the proxy, since the user must change this using the browser configuration settings. Hence, the proxy configuration is browser-specific and cannot be set up or modified for individual clients.

Therefore, there is a need for a mechanism that allows a flexible and dynamic solution for specifying a proxy server that allows a client to communicate with multiple HTTP servers through this proxy server.

URL information is known from T. Berners-Lee et al., Uniform Resource Locators (URL), Network Working Group, RFC 1738, pp. 1-25, December 1994. URI information is known from T. Berners-Lee et al., Uniform Resource Identifiers (URI) in WWW, Network Working Group, RFC 1630, pp. 1-28, June 1994. HTML information is known from T. Berners-Lee et al., Hypertext Markup Language (HTML) 2.0, Network Computing Group, RFC 1866, pp. 1-77, November 1995. XML information is known from “Extensible Markup Language (XML) 1.0 (Second Edition)”, T. Bray, J. Paoli, C.M. Sperberg-McQueen, E. Maler, editors, Oct. 6, 2000. XSL information is known from “Extensible Stylesheet Language (XSL) Version 1.0”, S. Adler, A. Berglund, J. Caruso, S. Deach, P. Grosso, E. Gutentag, A. Milowski, S. Parnell, J. Richman, S. Zilles, editors, Nov. 21, 2000. HTTP information is known from T. Berners-Lee et al., Hypertext Transfer Protocol (HTTP), CERN, December 1991.

### BRIEF SUMMARY OF THE INVENTION

In one aspect of the present invention, a method is provided for communicating with multiple HTTP servers through a HTTP proxy server from HTML/XSL based web pages. The method includes a mechanism by which clients can encode special information within the URI that specifies the proxy server and actual server. Also provided is a method for the client to transmit a request without a proxy header, the server will recognize and handle proxying if necessary. The present invention provides mechanisms to encode all URL links that are in the file received by the request.

This brief summary has been provided so that the nature of the invention may be understood quickly. A more complete understanding of the invention can be obtained by reference to the following detailed description of the preferred embodiments thereof, in connection with the attached drawings.

### BRIEF DESCRIPTION OF THE DRAWINGS

FIG. 1 is a diagram of a network architecture that may be used to implement the present invention.

FIG. 2 is a diagram of a system or workstation that may be used to implement the present invention.

FIG. 3 is a block diagram of an internal architecture on the workstation that may be used to implement the present invention.

FIG. 4 is a block diagram of a system for communicating with multiple HTTP servers through a HTTP proxy server, according to one aspect of the present invention.

FIG. 5 is a block diagram overviewing the process steps that may be executed, according to one aspect of the present invention.

FIG. 6 is a script showing usage of the JavaScript Helper Module in mangling URLs.

FIG. 7 is a flowchart describing the process steps performed when using the JavaScript Helper Module, according to one aspect of the present invention.

FIG. 7A describes the format used to specify the proxy and remote server information, according to one aspect of the present invention.

FIG. 8 shows the mechanism used within the JavaScript Helper Module to perform URL extraction, according to one aspect of the present invention.

FIG. 9 shows the mechanism used to write an IMG tag within a mangled URL, according to one aspect of the present invention.

FIG. 10 is a flow diagram of executable process steps for describing the HTTP Proxy Server Module, according to one aspect of the present invention.

FIG. 11 shows a flow diagram of executable process steps for the XSL Helper Module, according to one aspect of the present invention.

FIG. 12 is a function that shows the JavaScript mechanism in the XSL Helper Module that inserts the proxy information into a XSL query, according to one aspect of the present invention.

FIG. 13 is a code snippet within the XSL stylesheets that uses the XSL Helper Module templates to insert objects, according to one aspect of the present invention.

FIG. 14 is a code snippet showing the XSL mechanism within the XSL Helper Module that is used to extract the proxy information embedded in the XML query, according to one aspect of the present invention.

FIG. 15 shows the template within the XSL Helper Module used to insert images, according to one aspect of the present invention.

Features appearing in multiple figures with the same reference numeral are the same unless otherwise indicated.

### DETAILED DESCRIPTION OF THE INVENTION

Definitions and Brief Description of Terms: The following definitions are used in various aspects of the present invention with respect to computer networks(but not exclusively):

“HTTP”: HTTP, Hyper Text Transfer Protocol, is a protocol used to request and transmit files over the Internet or other computer network. This protocol is used to transfer requests between servers and browsers.

“HTML”: HTML, Hyper Text Markup Language, is a markup language used to structure text and documents and to set up hypertext links between the documents. The language is defined by a set of tags and rules for using them in creating hypertext documents.

“XML”: XML, Extensible Markup Language, is a metalanguage written in SGML (Standard Generalized Markup Language ) that is used to design a markup language. This is used to allow for the interchange of documents on the World Wide Web.

“XSL”: XSL, Extensible Stylesheet Language, is a standard for defining stylesheets for and in XML.

“URI”: URI, Universal Resource Identifier, is the generic set of names and addresses that refer to objects, usually on the Internet. A URL (Uniform Resource Locator ) is a common type of URI.

“Proxy server”: a Proxy server (particularly on the world wide web) that accepts URLs with a special prefix. The proxy server strips off the prefix and looks for the resulting URL in its local cache. If found, the document is returned to the requester. If not found, it is fetched from a remote server and then returned to the requester.

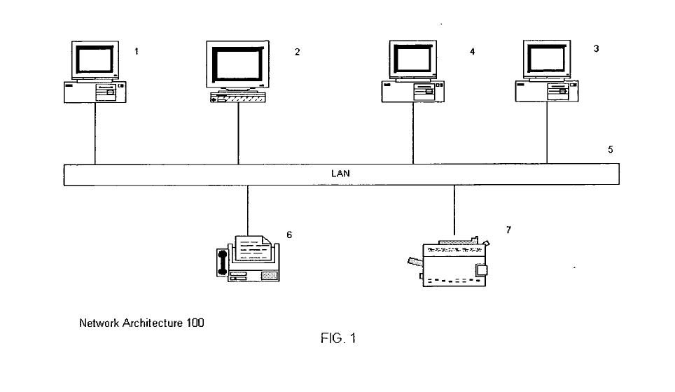

To understand the various adaptive aspects of the present invention, a brief description of a network, a system containing the invention and a block diagram of the internal architecture of the system is provided with respect to FIGS. 1 through 3.

Turning in detail to FIG. 1, network architecture 100 is shown that may be used to implement the various adaptive aspects of the present invention. Plural computer workstations, such as 1, 2, 3 and 4 are connected to the local area network (LAN) 5. Workstations 1, 2, 3 and 4 may each comprise a standard workstation PC. Other workstations, such as Unix workstations may also be included in the network and could be used in conjunction with workstations 1, 2, 3 and 4.

Workstations, such as 1, 2, 3 or 4, may be able to communicate with networked peripherals such as 6 and 7.

One skilled in the art can appreciate that the foregoing devices are coupled to the LAN 5 through a LAN interface (not shown) such as an Ethernet interface 10 Base-2 with a Coax connector or 10 Base-T with an RJ-45 connector. The present invention may also use LAN Token-Ring architecture.

Typically, a LAN serves a localized group of users within the same building. As users become more remote from one another, for example, in different buildings, a wide area network (WAN) (not shown) may be created. In one aspect, the present invention may be adapted to operate with a WAN.

LAN 5 supports data packets transmitted according to the TCP/IP network protocol (IP-packets). Each of these packets includes a destination field, a source field, a data field, a field indicating the length of the data field, and a checksum field. It is noteworthy that the present invention is not limited to TCP/IP but may be implemented using other communication protocols as well.

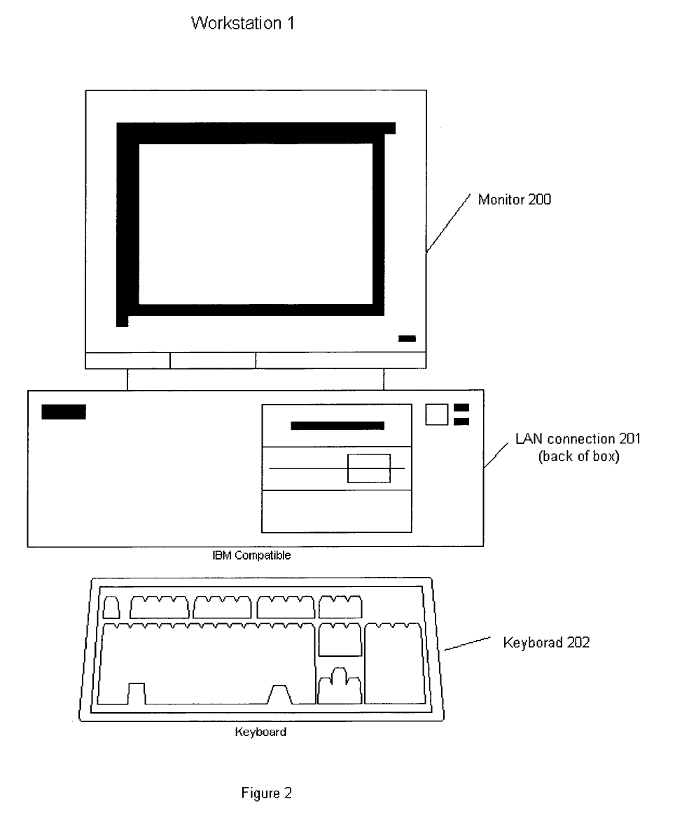

FIG. 2 is an outward view showing a representative workstation (Workstation 1) embodying the present invention. Workstation 1 may operate under various operating systems, e.g., Microsoft Windows NT, Microsoft Windows 2000 or Sun Microsystems Solaris. Workstation 1 includes a monitor with display area 201 that may be used to display information, workstation 1 also contains a keyboard 203 that can be used for inputting commands and/or data.

Workstation 1 interfaces with LAN 5 via connection 202, (not shown—on the back of the box).

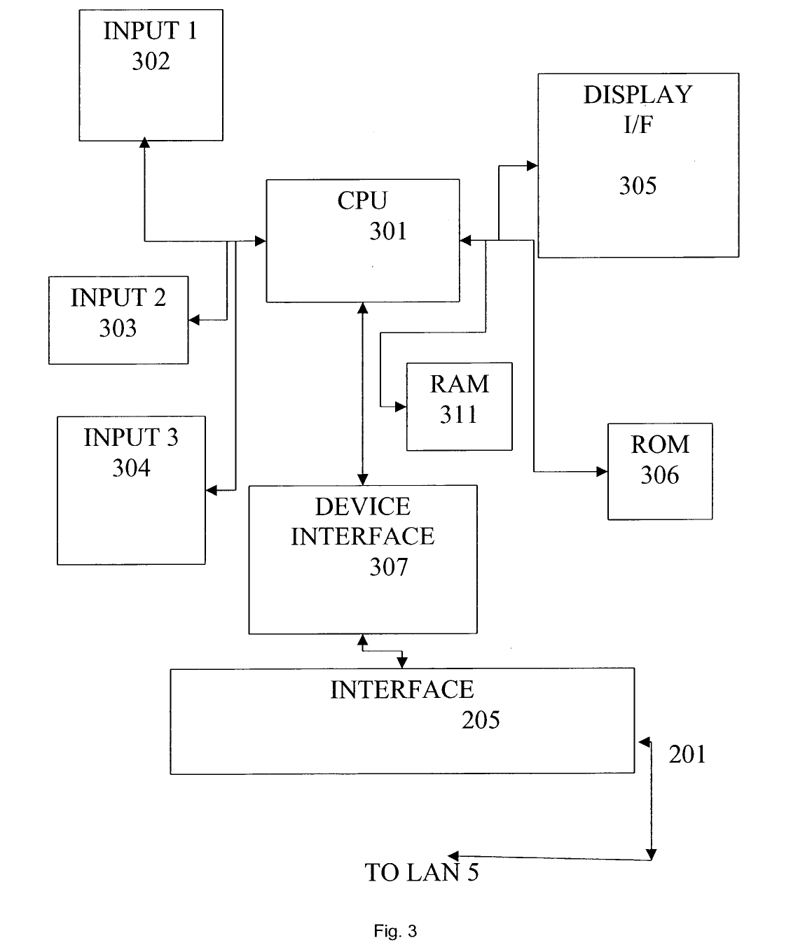

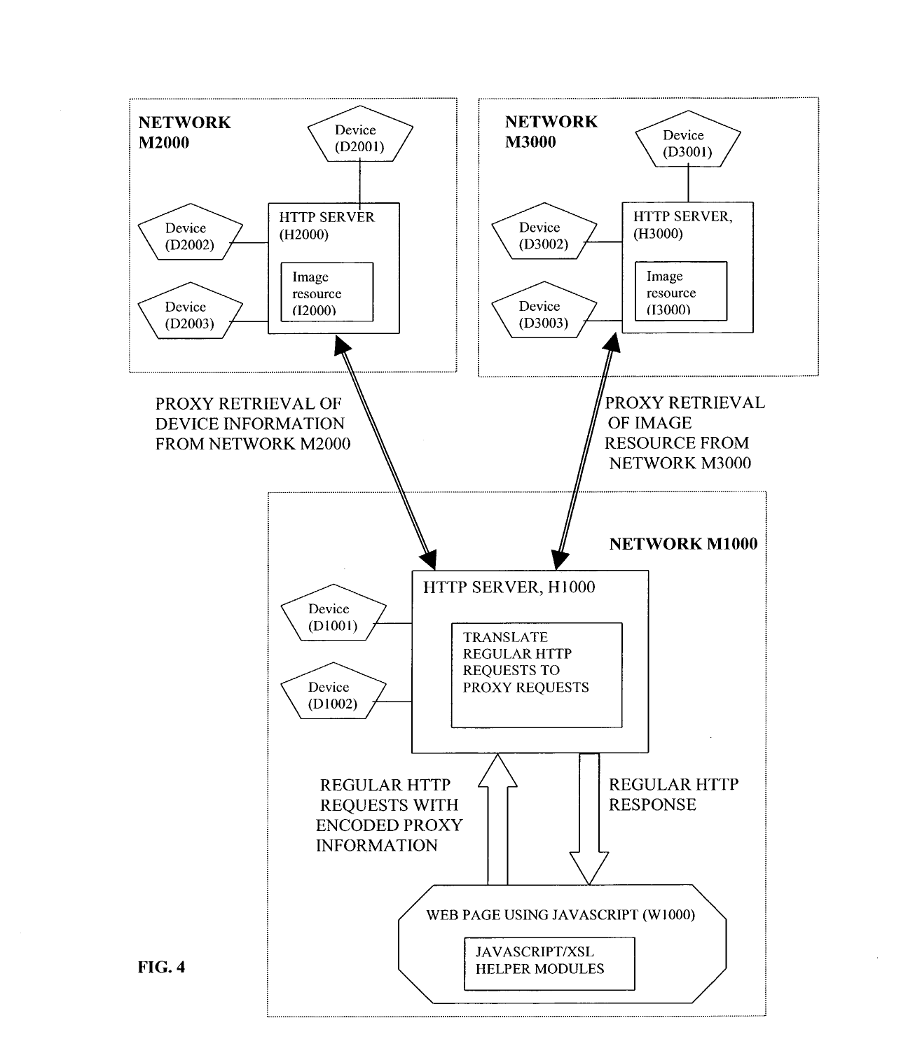

FIG. 3 is a block diagram showing the internal functional architecture of workstation 1. As shown in FIG. 3, workstation 1 includes central processing unit (“CPU”) 301 that interfaces with various components described below and is used for executing computer-executable process steps including those discussed below.

CPU 301 may receive input from various sources including a keyboard 202 via a keyboard interface 302, mouse 203 via mouse interface 303; and other external sources, via interface 304.

CPU 301 also interfaces with device interface 307 that allows workstation 1 to be connected to a LAN via interface 205.

CPU 301 also interfaces with a display interface 305 for displaying data in display area 202.

A random access main memory (“RAM”) 311 also interfaces with CPU 301 to provide CPU 301 with access to memory storage. When executing stored computer-executable process steps CPU 301 stores those process steps in RAM 311 and executes the stored process steps out of RAM 311.

Read only memory (“ROM”) 306 is provided to store invariant instruction sequences such as start-up instruction sequences or basic Input/output operating system (BIOS) sequences. ROM 306 may also store basic programs, e.g., address book, calendar, memo pads and the operating system.

A Multiserver System

FIG. 4 is a top-level block diagram of a system that allows communicating with multiple HTTP servers through a HTTP proxy server from HTML/XSL based web pages. The system includes multiple HTTP servers and multiple devices that may reside on multiple networks such as M1000, M2000 and M3000.

FIG. 4 shows HTTP servers such as H1000, H2000 and H3000 running in these networks, and these servers are capable of providing information about devices present on their network, or local resources, such as image files. A web page (W1000) requests device information or image resources from its local HTTP server (H1000). The request is sent as a regular HTTP request, i.e., the HTTP headers do not indicate that the HTTP server is required to do proxying. However, with the aid of XSL and Javascript helper methods, the request URI and message body is modified to incorporate additional information regarding the location of the requested resource. Any and all links present within the retrieved resource are specified using relative links, which are transformed by the Javascript and XSL helper methods to include the proxy information after retrieval.

The HTTP server H1000 decodes this additional information and decides whether the resource to be retrieved is local, such as the image file I1000 or remote, such as the image file I2000 present in the network M2000. If the requested resource or device information needs to be retrieved from a remote network, such as M2000 or M3000, the HTTP server H1000 acts as a proxy server and issues a proxy request to the appropriate server. The resource thus retrieved is transmitted back to the client. By this mechanism, the client web browser leverages proxy capabilities of the server H1000, and uses those capabilities to communicate with multiple servers, without any modification of HTTP headers.

It is noteworthy that the invention is not limited to the foregoing modules. The system may have more sub-modules or have all the modules integrated in various ways.

Multiserver Mechanism

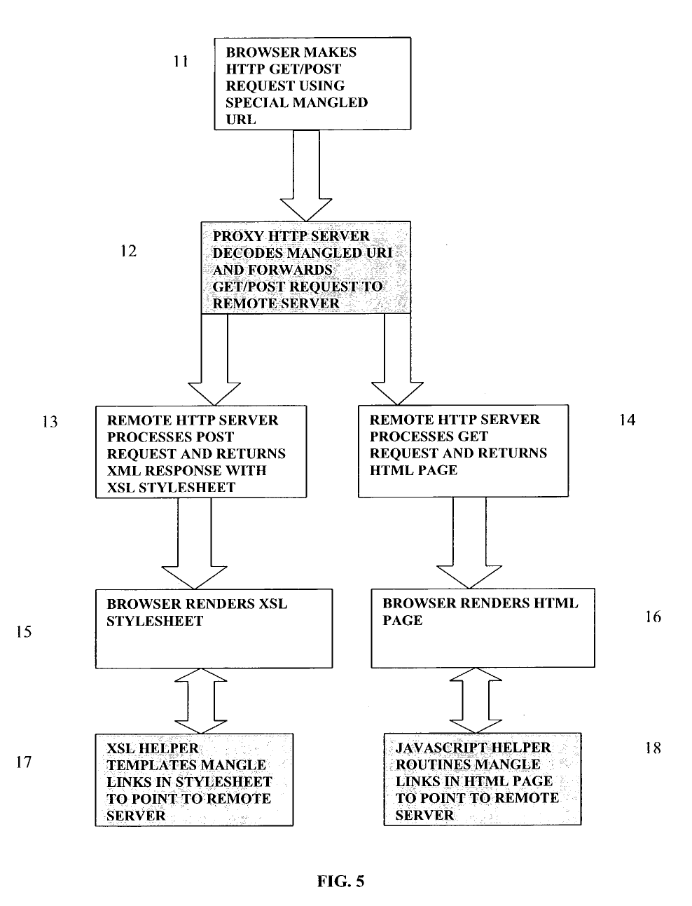

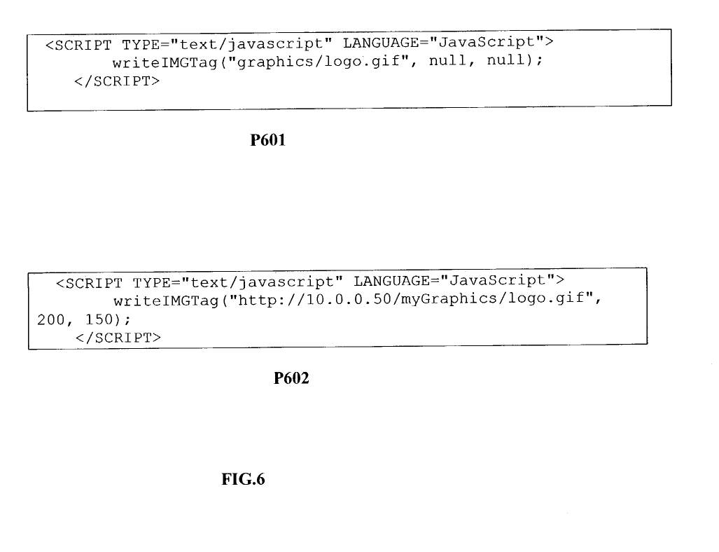

The remote HTTP server, 13 and 14 in FIG. 5, responds to standard GET Requests and POST requests containing XML queries encoded in the message body from the client, 11 in FIG. 5, which sends the requests using a URL mangling scheme through a Proxy HTTP server, 12 in FIG. 5.

Since the servers can function as HTTP Proxy servers, 12 in FIG. 5, they enable clients, 11 in FIG. 5, which could be browsers running behind a firewall to communicate with other, remote servers, 13 and 14 in FIG. 5. The standard way of allowing web pages to use HTTP Proxy servers, however, requires reconfiguring the browser to direct all HTTP requests to go through a HTTP Proxy server. This is unacceptable in many situations for three reasons:

This forces other web pages to use the same HTTP Proxy server, because they share the browser's configuration settings. This may not be in accordance with the network setup where some other server may already be set up as the HTTP proxy.

This restricts client pages from dynamically modifying the address of the server used as a HTTP proxy, since the user is always required to change it using the browser's configuration settings.

The configuration is browser-specific, hence cannot be described or modified for all clients.

The present invention provides a mechanism by which clients can send HTTP POST Requests containing XML queries, 11 in FIG. 5, and receive responses that are subsequently rendered using XSL stylesheets or send HTTP GET Requests for files, by dynamically specifying the HTTP Proxy server, 12 in FIG. 5, to be used and the actual server that is to process the request, 13 and 14 in FIG. 5. This process does not require modification of any HTTP headers, and hence can be done from within any web page running in any browser that supports JavaScript, 11 in FIG. 5. The present invention does not require the user to change the HTTP Proxy settings on the browser and hence does not affect the proxy server used by other web pages

Further, the present invention allows the links in the pages that have been retrieved from the remote server to dynamically point to the remote server. This is done in two separate cases:

If the client, 15 in FIG. 5 gets a HTML file in response to a GET request, and the file contains links to other files on the remote server, the JavaScript Helper Component of the present invention, 17 in FIG. 5, dynamically mangles all URLs in the HTML file to point to the remote server.

If the client, 16 in FIG. 5, renders a XML document retrieved in response to a POST request using a XSL stylesheet, the XSL Helper Component of the present invention, 18 in FIG. 5, dynamically mangles all URLs in the XSL file to point to the remote server.

Referring to the system diagram in FIG. 4, the XML document retrieved (13 in FIG. 5) could be device information from network M2000 and the HTML information retrieved (14 in FIG. 5) could be the image resource from network M3000 with the proxy HTTP server (12 in FIG. 5) corresponding to the server H1000 on the network M1000.

In summary, the present invention works in three stages:

Encoding special information within the URI that designates the proxy server and the actual server address.

Transmitting the request without the proxy header, but instead having the server recognize the need for proxying while decoding the URL, 12 in FIG. 5.

Providing JavaScript and/or XSL mechanisms to encode all URL links present within the file retrieved by the GET/POST request. This allows the relative links to be specified within the retrieved file, which are resolved into absolute links “just in time” when the file is being rendered by the browser.

Javascript Helper Module

The system diagram in FIG. 4 shows a web page containing links to other resources, which are rendered to include the proxy information “just in time” using the Javascript Helper Module.

FIG. 6 shows the usage of the JavaScript Helper Module (JHM) in mangling URLs that are to be used to access a resource on the remote HTTP server. This figure shows, in particular, two forms of the writeIMGTag( ) JavaScript method, which is used to write IMG tags for images in a HTML page.

P601 in FIG. 6 shows the usage of writeIMGTag( ) for a GIF file without position information being inserted into a HTML page. Furthermore, this GIF file is specified using a relative path from location of the HTML file into which it is to be embedded.

P602 in FIG. 6 shows the usage of writeIMGTag( ) for a GIF file that is to be inserted into a specified position on a HTML page. Furthermore, this GIF is specified using an absolute path. Note that the HTTP server specified in the absolute path need not be accessible from the browser where the HTML page is being displayed—it merely needs to be accessible from the proxy server.

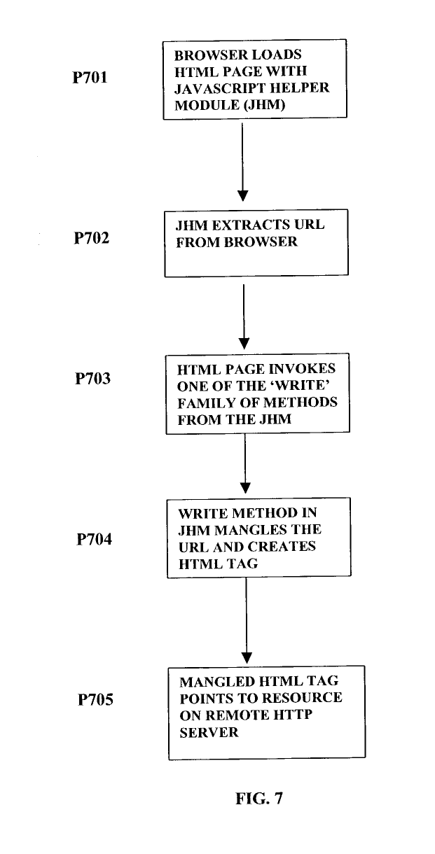

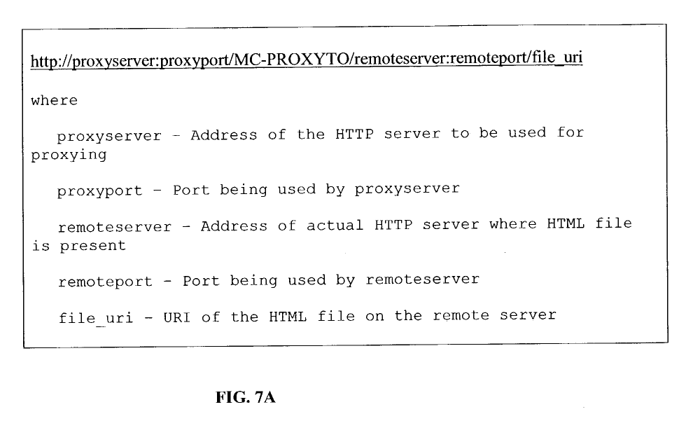

FIG. 7 shows the processing steps performed when using the JavaScript Helper Module.

The processing commences in P701 where the browser loads a HTML page that contains a reference to the JHM. The user specifies the server where the HTML file is present along with the proxy server to be used by using the format shown in FIG. 7A.

P702 in FIG. 7 shows the JHM getting initialized, and the initialization process extracts the Proxy Server address and the Actual (or remote) Server address from the URL of the source HTML page.

P703 in FIG. 7 shows the HTML page invoking one of the ‘Write’ family of methods in the JHM to write a specific type of HTML with its URL mangled correctly. The Write family of methods includes a method for each type of HTML tag that takes a URL argument. This includes SCRIPT tags, IMG tags, FORM tags and LINK tags. The JHM also provides a mechanism for the HREF to get mangled directly, as will be explained in later section.

P704 in FIG. 7 shows the Write method inside the JHM mangling the URL provided and writing the HTML tag with the mangled URL that now points to the remote HTTP server, via the specified HTTP proxy.

P705 in FIG. 7 shows the Browser requesting the specified resource from the remote HTTP server through the specified HTTP proxy.

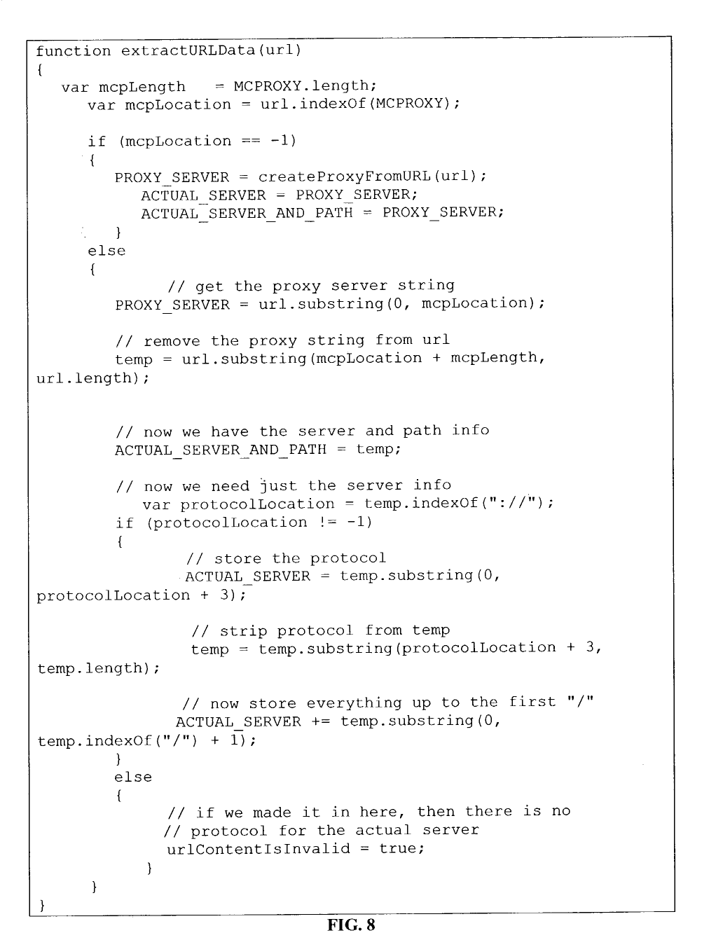

FIG. 8 shows the mechanism used within the JHM to perform the URL extraction corresponding to P702. As can be seen from FIG. 8, the JHM analyzes the URL of the source HTML page and breaks it into the proxy server and remote server portions. If the special MCPROXY-TO is not present as part of the URL, then the specified resource is present on the proxy server itself, and hence the proxy and remote server addresses are the same. If MCPROXY-TO is present, then the JHM stores the proxy and remote server addresses for future use by the mangling methods.

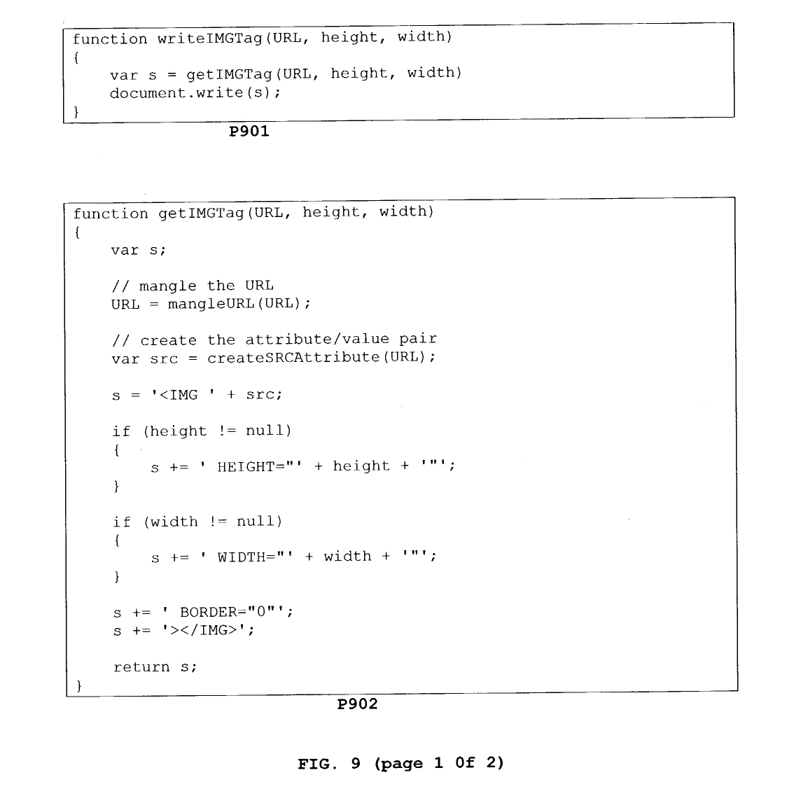

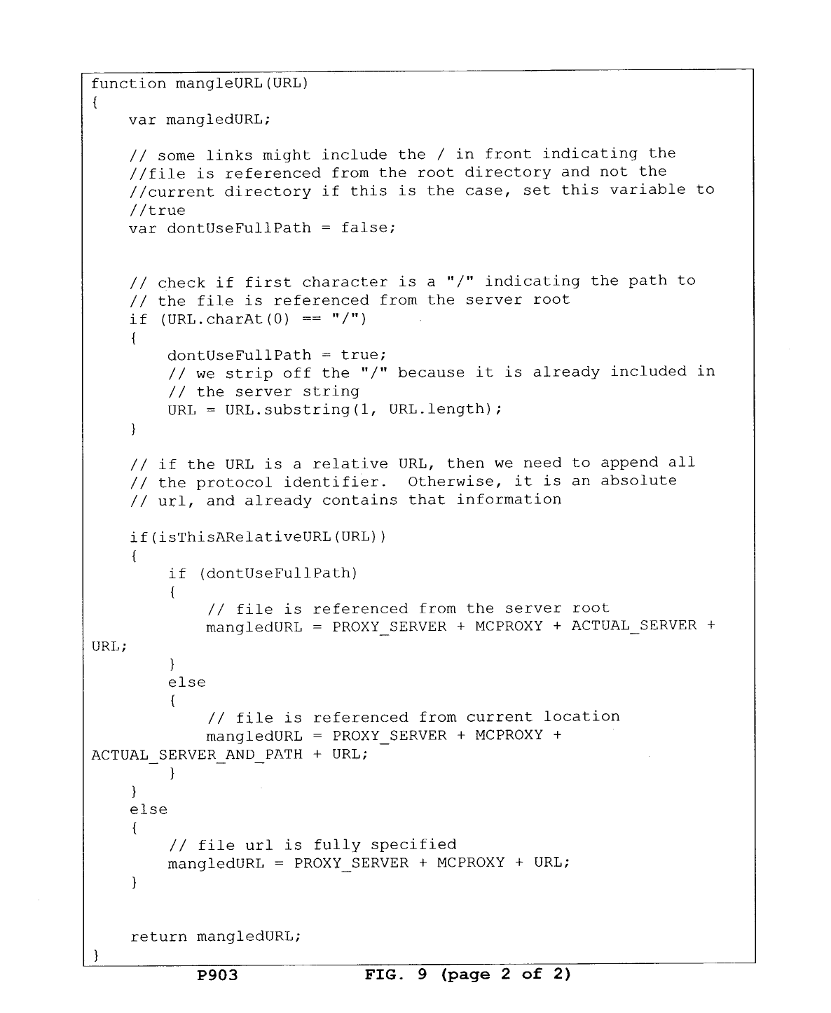

P901 and P902 in FIG. 9 shows the mechanism used to write an IMG tag with a mangled URL. The IMG tag is used as an example, and the same mechanism could be adopted for use with any kind of HTML tag. As can be seen from P901 and P902, the JHM mangles the URL for the IMG tag and writes the other attributes of the tag as specified.

P903 in FIG. 9 shows the mangling process within the JHM. As seen in P903, the JHM will mangle absolute URL references, relative URL references from the server root and relative URL references from the source HTML file. After detecting the type of URL being passed in, the JHM uses the proxy and remote server information extracted in FIG. 9 to construct the mangled URL.

HTTP Proxy Server Module

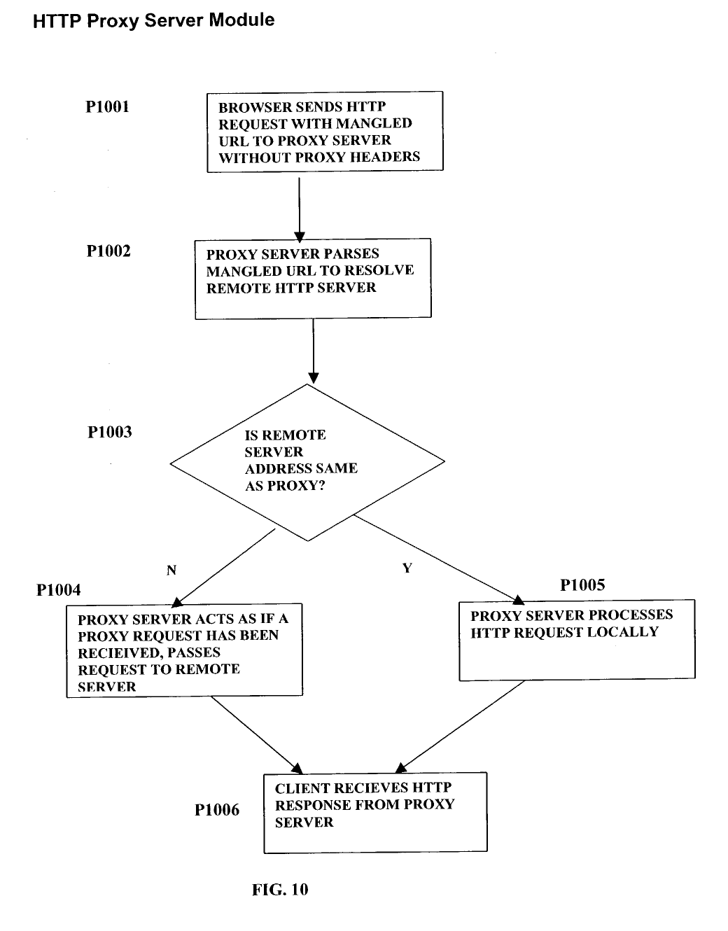

The system diagram in FIG. 4 has a HTTP server (H1000) processing the client requests and decoding the URI to decide if a proxy request needs to be issued. FIG. 10 examines the processing logic used by this server in more detail.

P1001 in FIG. 10 shows the browser sending a HTTP request, either a POST or a GET with a mangled URL. The mangled URL consists of the format defined in FIG. 7A and, as shown there, contains the proxy server and actual server addresses. The HTTP request is sent with the standard HTTP headers, i.e., the HTTP headers do not indicate that the HTTP server as a proxy server.

P1002 in FIG. 10 shows the HTTP Proxy server parsing the URI submitted by the browser to check if it contains the MCPROXY-TO directive. If this directive is present, the HTTP Proxy server breaks the URL into the proxy server address and the remote server address components.

P1003 in FIG. 10 shows the HTTP Proxy server checking to see if the remote server address specified matches any of the addresses it is bound to. If a match is returned the HTTP request is for a file present locally on the Proxy server.

P1004 in FIG. 10 shows the processing in case the remote server address is not local. In this case, the Proxy server behaves exactly as it would if it had received a Proxy request from the browser for the remote server: forwarding the HTTP request to the remote server and returning the response to the client.

P1005 in FIG. 10 shows the processing in case the remote server address resolves to one of the addresses that the Proxy server is bound to. In this case, the Proxy server processes the HTTP request locally.

P1006 in FIG. 10 shows the browser getting a response from the Proxy server, though the actual data might have been retrieved from a remote server.

XSL Helper Module

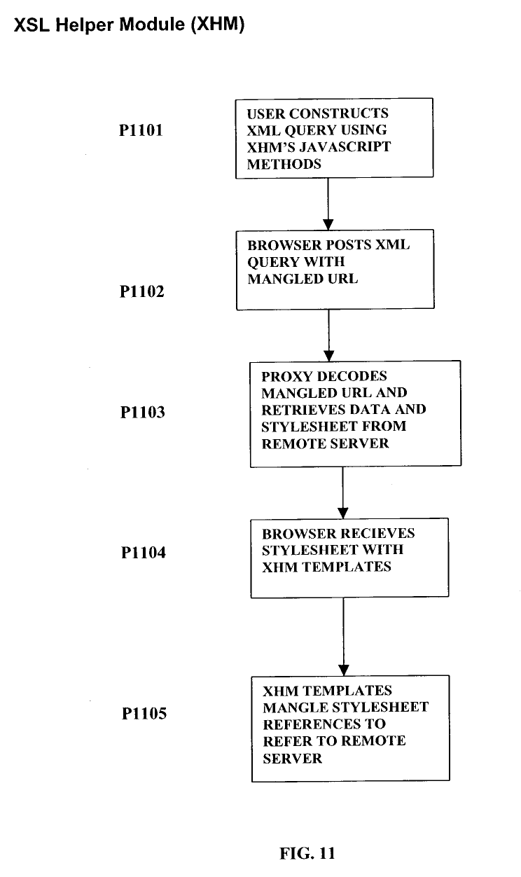

P1101 in FIG. 11 shows the user constructing a XML Query to send to the HTTP server using a HTTP POST request. Prior to submitting the POST, the user calls on the XSL Helper Module's (XHM's) JavaScript methods for inserting Proxy Server information into the XML query. After this step, the XML query contains embedded information that can be used by the XHM's XSL templates to mangle stylesheet URLs.

P1102 in FIG. 11 shows the browser submitting the HTTP POST request, with the XML query in the message body of the POST, to the Proxy Server. The URI field of the POST request contains a mangled URL and the XML query itself contains an embedded stylesheet directive that points to the XSL on the remote server using the URL mangling mechanism. The format for mangled URLs is defined in the discussion of P701.

P1103 in FIG. 11 shows the Proxy Server retrieving the data specified in the POST request from the remote server, along with the stylesheet specified in the XML query.

P1104 in FIG. 11 shows the browser rendering the stylesheet retrieved from the remote server. If the stylesheet includes additional files, such as script files, images or other stylesheets, it specifies the location of these additional files using the XHM's templates for inserting the given component.

P1105 in FIG. 11 shows the XHM template mangling the URL reference within the stylesheet to point to the remote server, using the Proxy Server. Hence, the additional files are retrieved from the same location as the original stylesheet.

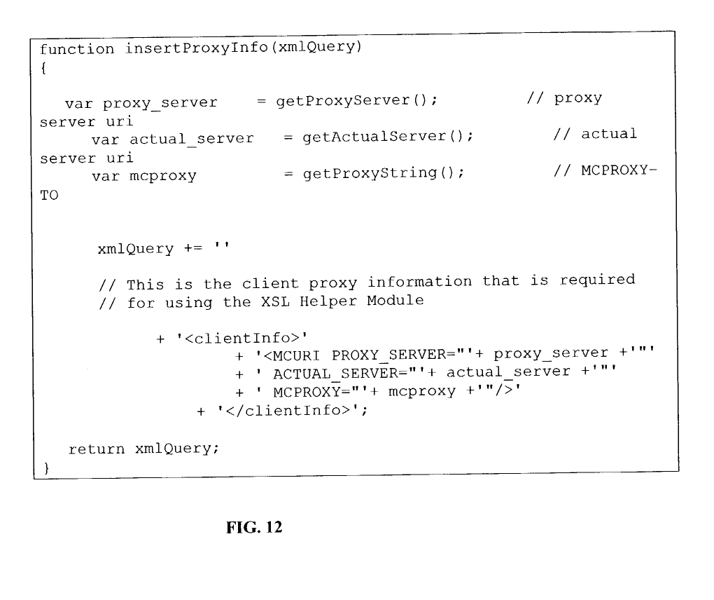

FIG. 12 shows the JavaScript mechanism in the XHM that inserts the proxy information into a XML query. This mechanism makes use of the same variables that were extracted by the JavaScript Helper Module in FIG. 8. These variables are inserted as attributes of the MCURI element of the XML query document.

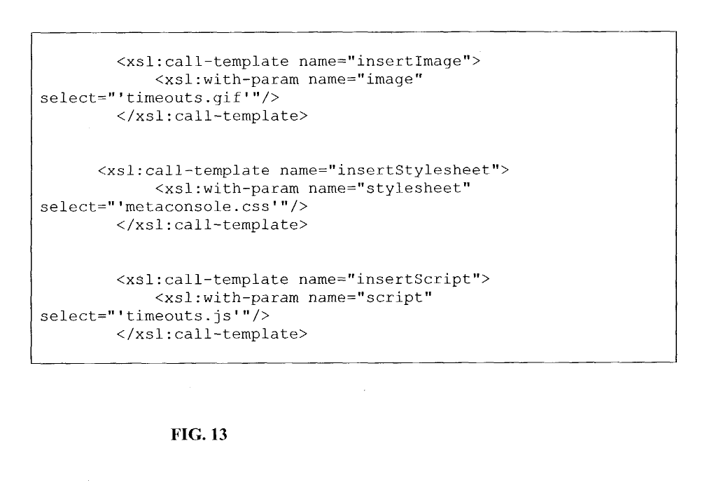

FIG. 13 shows code within XSL stylesheets that uses XHM templates to insert various types of objects. The examples shown in FIG. 13 insert an image, a stylesheet and a script into the source stylesheet. These objects, after insertion, will have their locations pointing to the remote server using a mangled URL.

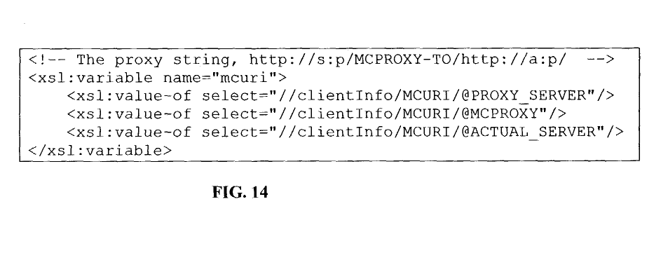

FIG. 14 shows the XSL mechanism within the XHM that is used to extract the proxy information embedded in the XML query. The Proxy Server address, the special directive used within the URL to tell the server to do proxying and the remote server address are all extracted from within the XML query.

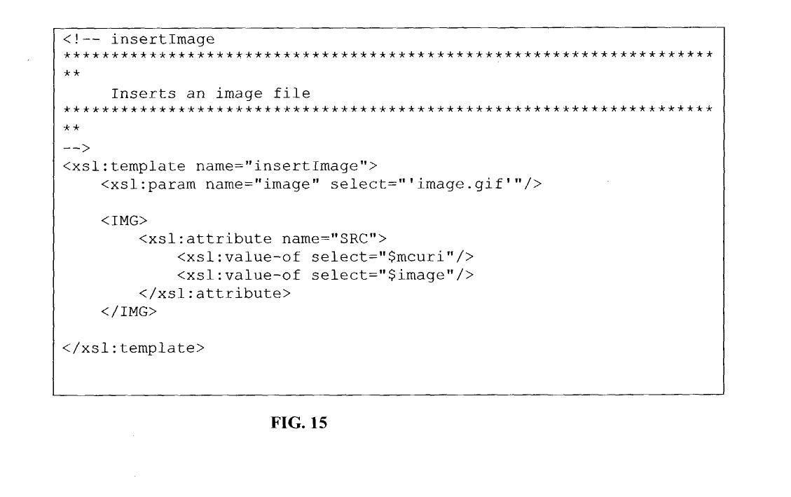

FIG. 15 shows the template within the XHM used to insert images. This template, whose usage is described earlier in FIG. 13, inserts an IMG tag within the stylesheet whose SRC attribute is mangled to point to the remote server using the variables that were extracted in FIG. 14.

While the present invention is described above with respect to what is currently considered it's preferred embodiments, it is to be understood that the invention is not limited to that described above.

What is claimed is:

1. A method for communicating with multiple HTTP servers through a proxy server from HTML/XSL based web pages, comprising:
encoding special information within the URI that designates the proxy server and the actual server address.

2. The method of claim 1, further comprising:
transmitting the request without a proxy header, but instead having the server recognize the need for proxying while decoding the URL.

3. The method of claim 1, further comprising:
providing JavaScript and/or XSL mechanisms to encode all URL links present within the file retrieved by the GET/POST request, allowing relative links to be specified within the retrieved file that are resolved into absolute links when the file is rendered by the client.
